(19) United States
(12) Patent Application Publication
(10) Pub. No.: US 2017/0032494 A1
(43) Pub. Date: Feb. 2, 2017

(54) METHODS FOR DISPLAYING A WEBPAGE FRAGMENT ON A DESKTOP AND SYSTEMS FOR TAKING A SNAPSHOT OF WEBPAGE FRAGMENT FOR DISPLAYING ON A DESKTOP

(71) Applicants: Zhijun YUAN, Hangzhou, Zhejiang (CN); Xiaodan DAI, Hangzhou, Zhejiang (CN); ALIBABA GROUP HOLDING LIMITED, George Town, Grand Cayman (KY)

(72) Inventors: Zhijun YUAN, Hangzhou (CN); Xiaodan DAI, Hangzhou (CN)

(21) Appl. No.: 15/303,517

(22) PCT Filed: Apr. 8, 2015
(86) PCT No.: PCT/CN2015/076057

§ 371 Date: Oct. 11, 2016

(30) Foreign Application Priority Data
Apr. 11, 2014 (CN) 201410144302.6

(51) Int. Cl. G06T 3/40; G06F 17/27; G06F 17/22; G06F 17/30

(52) U.S. Cl. CPC G06T 3/4092; G06F 17/30896; G06F 17/30887; G06F 17/272; G06F 17/2247; H04L 67/02

(57) ABSTRACT

The present application discloses a method for displaying a webpage fragment on a desktop, comprising: receiving feature information of webpage fragment corresponding to a webpage fragment sent by a sending terminal; sending a request to a server based on the feature information of webpage fragment, and acquiring data of webpage fragment corresponding to the webpage fragment; and displaying the data of webpage fragment to a current desktop. The present application also discloses an apparatus for displaying a webpage fragment on a desktop, a method for acquiring and transmitting feature information of webpage fragment, an apparatus for acquiring and transmitting feature information of webpage fragment, a method for acquiring and processing webpage resources, an apparatus for acquiring and processing webpage resources, and a system for taking a snapshot of webpage fragment to display on a desktop. Through the solutions of the present application, a snapshot of webpage can be displayed on different terminals. These solutions can be widely used and can keep the data of the displayed webpage snapshot updated. The implementation is simple and convenient.

### CROSS REFERENCE TO RELATED APPLICATION

This application is the U.S. national stage application under 35 U.S.C. §371 of International Application No. PCT/CN2015/076057, filed on Apr. 8, 2015, which claims priority to and the benefits of priority to Chinese Application No. CN 201410144302.6, filed on Apr. 11, 2014, the entire contents of both applications are incorporated herein by reference.

### TECHNICAL FIELD

The present disclosure relates to the field of displaying a webpage fragment, and in particular, to methods, apparatuses, and systems for displaying a webpage fragment on a desktop.

### BACKGROUND

With the continuous development of Internet technologies, content on the Internet becomes increasingly rich, and more and more webpages are available for users to browse. Some related services such as webpage favourites and website recommendations appear so that users can manage and browse webpages conveniently. The related services such as webpage favourites and website recommendation generally provide a series of uniform resource locator (URL) lists or webpage name lists for a user. After the user clicks a desired URL or a webpage name, corresponding webpage content can be acquired according to the URL or a URL corresponding to the webpage name. The webpage content can be then loaded and rendered, so that the user can browse the desired webpage quickly. Compared with a URL or a webpage name, information provided in a form of a webpage fragment is more intuitive and richer. Therefore, many websites recommend their products or expand their advertisement by using webpages of the websites. And, it is accepted by more and more users to provide a webpage fragment function in the services such as the aforementioned webpage favourites and website recommendations.

In the prior art, there are two main methods for implementing the aforementioned webpage fragments as follows:

One method is to display, on a desktop, a Web fragment in a form of a component in an Android system. In this technology, a widget specially for a certain web fragment is developed based on a Web Widget technology. This widget can carry a view of a webpage and the view is directed to the URL of the webpage. Finally, the webpage fragment is displayed on the desktop in a hyperlink manner.

The other method is to display a webpage fragment on a desktop by using a Web Clip function in a Mac OS system. In this technology, a website is first visited by using the Safari browser of Apple. Then a webpage fragment of the current webpage of the Safari browser is snapshotted by using the Web Clip function of the Mac OS system. The webpage fragment is put into a Dashboard (which is a part of a Mac desktop), so that a user can access content in the webpage fragment at any time. In addition, the webpage fragment has an automatic update function.

The aforementioned prior art has disadvantages.

As for the technology of displaying, on a desktop, a Web fragment in the form of a component in an Android system, first of all, the technology can only be implemented in mobile terminals with an Android system, which is limited to a certain degree. Second, to implement this technology, an independent widget needs to be developed for each piece of particular content, and users are not allowed to define display content by themselves, which is unfavorable for the promotion of the technology. In addition, the technology cannot intuitively display content of the webpage, and a special operation needs to be performed to view related content, which is inconvenient for implementation.

As for the technology of displaying a webpage fragment on a desktop by using a Web Clip function in a Mac OS system, first of all, the technology can only be implemented on Mac computers, and the webpage fragment cannot be displayed on other terminals, which is limited to a certain degree. Second, the technology is restricted in a way that only the Safari browser of Apple can be used to snapshot the webpage fragment, which is also a limitation.

In accordance with the aforementioned reasons, the displaying technologies based on the existing technologies have certain limitation. Those existing technologies are hardly applied to other applications or platforms universally, and are inconvenient for implementation.

### SUMMARY

The present application discloses a method for displaying a webpage fragment on a desktop to resolve the difficulty of applying universally and the inconvenience of implementation. The present application also discloses an apparatus for displaying a webpage fragment on a desktop, a method for acquiring and transmitting feature information of webpage fragment, an apparatus for acquiring and transmitting feature information of webpage fragment, a method for acquiring and processing webpage resources, an apparatus for acquiring and processing webpage resources, and a system for taking a snapshot of webpage fragment to display on a desktop.

The application provides a method for displaying a webpage fragment on a desktop, the method comprising:

receiving feature information of webpage fragment corresponding to the webpage fragment sent by a sending terminal;

sending a request to a server based on the feature information of webpage fragment, and acquiring data of webpage fragment corresponding to the webpage fragment; and

displaying the data of webpage fragment to a current desktop.

In some embodiments, the feature information of webpage fragment includes:

a URL of a webpage corresponding to the webpage fragment, screen resolution of the sending terminal, and size and location information of the webpage fragment; or

a URL of a webpage corresponding to the webpage fragment, screen resolution of the sending terminal, and location information of all vertices of the webpage fragment.

In some embodiments, after displaying a webpage fragment control, generated from the data of webpage fragment, on the current desktop, the method further comprises:

executing the following step of data update in accordance with a set cycle: sending a request to the server based on the feature information of webpage fragment; acquiring the data of webpage fragment corresponding to the webpage fragment; and displaying a webpage fragment control generated from the data of webpage fragment on the current desktop.

In some embodiments, the webpage fragment includes:

a screenshot of the whole current webpage in a browser of the sending terminal; or a screenshot of a part of the current webpage in a browser of the sending terminal.

In some embodiments, sending the request to the server based on the feature information of webpage fragment and acquiring the data of webpage fragment corresponding to the webpage fragment include:

sending the request to a proxy server based on the feature information of webpage fragment; and

receiving the data of webpage fragment, returned by the proxy server, corresponding to the feature information of webpage fragment.

In some embodiments, sending the request to the server based on the feature information of webpage fragment and acquiring the data of webpage fragment corresponding to the webpage fragment include:

sending the request to a Web server based on the URL;

receiving all network resources related to the URL returned by the Web server; and

parsing the network resources based on the feature information of webpage fragment to acquire the data of webpage fragment corresponding to the webpage fragment.

In some embodiments, the data of webpage fragment includes the Hypertext Markup Language (HTML) codes of the webpage fragment and the resources of the webpage fragment.

In some embodiments, displaying the data of webpage fragment to the current desktop includes:

loading the resources of the webpage fragment based on the HTML codes of the webpage fragment;

performing standard parsing on the HTML codes of the webpage fragment, and then obtaining a webpage fragment control; and

performing scaling on the webpage fragment control based on screen resolution of the current desktop, and then displaying the webpage fragment control on the current desktop.

In some embodiments, sending the request to the Web server based on the URL, receiving the all network resources related to the URL returned by the Web server, and parsing the network resources based on the feature information of webpage fragment to acquire the data of webpage fragment corresponding to the webpage fragment are implemented based on an internal kernel of browser WebKit.

In some embodiments, parsing the network resources based on the feature information of webpage fragment to acquire the data of webpage fragment corresponding to the webpage fragment is implemented based on a DumpRenderTree function in a browser kernel WebKit.

In some embodiments, the following steps are implemented based on a Web-based OS operating environment: the step of loading the webpage fragment resource based on the webpage fragment HTML codes, the step of obtaining a webpage fragment control after performing standard parsing and execution of webpage fragment HTML codes, and the step of performing scaling on the webpage fragment control based on screen resolution of the current desktop and then displaying the webpage fragment control on the current desktop.

The application also provides an apparatus for displaying a webpage fragment on a desktop, comprising:

a data receiving unit configured to receive feature information of webpage fragment corresponding to a webpage fragment sent by a sending terminal;

a data acquiring unit of webpage fragment configured to send a request to a server based on the feature information of webpage fragment, and acquire data of webpage fragment corresponding to the webpage fragment; and

a display unit of webpage fragment configured to display the data of webpage fragment to a current desktop.

In some embodiments, the apparatus for displaying the webpage fragment on the desktop further comprises:

a data update unit configured to: sending a request to the server based on the feature information of webpage fragment; acquiring the data of webpage fragment corresponding to the webpage fragment; and displaying a webpage fragment control, generated from the data of webpage fragment, on the current desktop.

In some embodiments, the data acquiring unit of webpage fragment includes:

a data request subunit configured to send the request to a proxy server based on the feature information of webpage fragment; and

a data receiving subunit configured to receive the data of webpage fragment, returned by the proxy server, corresponding to the feature information of webpage fragment.

In some embodiments, the display unit of webpage fragment includes:

a loading subunit of webpage resources configured to load the resources of the webpage fragment based on the HTML codes of the webpage fragment;

a code-parsing subunit configured to perform standard parsing on the HTML codes of the webpage fragment, and then obtaining a webpage fragment control; and

a display-scaling subunit configured to perform scaling on the webpage fragment control based on screen resolution of the current desktop, and then displaying the webpage fragment control on the current desktop.

The application further provides a method for acquiring and transmitting feature information of webpage fragment, comprising:

acquiring a webpage fragment by taking a screenshot of the current webpage in a browser;

obtaining feature information of webpage fragment corresponding to the webpage fragment; and

sending the feature information of webpage fragment to a receiving terminal.

In some embodiments, the feature information of webpage fragment includes:

a URL of a webpage corresponding to the webpage fragment, screen resolution of the sending terminal, and size and location information of the webpage fragment; or

a URL of a webpage corresponding to the webpage fragment, screen resolution of the sending terminal, and location information of all vertices of the webpage fragment.

In some embodiments, the URL is implemented based on the JavaScript Window Object.

In some embodiments, the screen resolution of the sending terminal is implemented based on the JavaScript Screen Object.

In some embodiments, before sending the feature information of webpage fragment to the receiving terminal, the method further comprises:

establishing a communication link with the receiving terminal, wherein the communication link includes one of the following forms:

a wired communication link;

a wireless communication link in a regional network established based on Wi-Fi or Bluetooth; and

a long-distance point-to-point communication link established on the Internet.

The application even further provides an apparatus for acquiring and transmitting feature information of webpage fragment, comprising:

an acquiring unit of webpage fragment configured to acquire a webpage fragment by taking a screenshot of the current webpage in a browser;

an obtaining unit of feature information configured to obtain feature information of webpage fragment corresponding to the webpage fragment; and

a data-sending unit configured to send the feature information of webpage fragment to a receiving terminal.

The application further provides a method for acquiring and processing webpage resources, comprising:

receiving a request, containing feature information of webpage fragment, for acquiring data of webpage fragment;

reading a URL from the feature information of webpage fragment;

sending a request to a Web server based on the URL;

receiving all network resources relevant to the URL returned from the Web server; and

parsing the network resources based on the feature information of webpage fragment to acquire data of webpage fragment corresponding to the webpage fragment.

In some embodiments, after parsing on the network resources based on the feature information of webpage fragment to acquire the data of webpage fragment corresponding to the webpage fragment, the method further comprises:

Sending the data of webpage fragment to a receiving terminal.

In some embodiments, the method is implemented based on a browser kernel WebKit.

In some embodiments, parsing the network resources based on the feature information of webpage fragment to acquire the data of webpage fragment corresponding to the webpage fragment are implemented based on an internal kernel of browser WebKit.

The application further provides an apparatus for acquiring and processing webpage resources, comprising:

a request-receiving unit configured to receive a request, containing feature information of webpage fragment, for acquiring data of webpage fragment;

a URL-reading unit configured to read a URL from the feature information of webpage fragment;

a data request unit configured to send a request to a Web server based on the URL;

a receiving unit of network resources configured to receive all network resources relevant to the URL returned from the Web server; and

a parsing unit of network resources configured to parse the network resources based on the feature information of webpage fragment to acquire data of webpage fragment corresponding to the webpage fragment.

In some embodiments, the apparatus for acquiring and processing webpage resources further comprises:

a data-sending unit configured to send the data of webpage fragment to a receiving terminal.

The application further provides a system for taking a snapshot of webpage fragment to display on a desktop, comprising:

a first terminal apparatus, the first terminal apparatus being equipped with the apparatus for acquiring and transmitting feature information of webpage fragment;

a second terminal apparatus, the second terminal apparatus being equipped with the apparatus for displaying the webpage fragment on the desktop; and

a server, the server being equipped with the apparatus for acquiring and processing webpage resources.

In some embodiments, the first terminal apparatus includes a PC.

In some embodiments, the second terminal apparatus includes a mobile phone, a tablet, a PC, and/or a television.

The application further provides a system for taking a snapshot of webpage fragment to display on a desktop, comprising:

a terminal apparatus, the terminal apparatus being equipped with the apparatus for acquiring and transmitting the feature information of webpage fragment and the apparatus for displaying the webpage fragment on the desktop; and

a server, the server being equipped with the apparatus for acquiring and processing webpage resources.

In some embodiments, the terminal apparatus includes a PC.

Compared to the existing technologies, the application has the following advantages:

The application provides a method for displaying a webpage fragment on a desktop to resolve the difficulty of applying universally and the inconvenience of implementation in the existing technologies.

In the technical solutions based on the existing technologies, when a client snapshots a webpage fragment in the current browser and displays the webpage fragment on the desktop, the operation is limited to be implemented in the specific operation (OS) system or the specific browser. In addition, an independent widget needs to be developed for each piece of particular content to display the content on the desktop. The technical solution of the application includes receiving feature information of webpage fragment corresponding to a webpage fragment sent by a sending terminal; sending a request to a server based on the feature information of webpage fragment, and acquiring data of webpage fragment corresponding to the webpage fragment; and displaying the data of webpage fragment to a current desktop. The technical solution of the application does not to develop an independent widget for each piece of particular content to display the content on the desktop. Its implementation is simple and convenient. The technical solution of the application exchanges the feature information of webpage fragment between two terminals. It implements the location and description of the content of webpage fragment at the target terminal. It also downloads the data information of the webpage fragment from the server based on the location and description of the webpage fragment. And, it displays at the target terminal by rendering. The approach allows the target terminal to obtain the content of information of webpage fragment efficiently and timely. It also reduces the volume of data transmissions and conserve the network resources. Specially, in the scenario of sharing information of webpage fragment between a PC terminal and a mobile terminal, the application may extremely reduce the volume of data transmission at the mobile terminal. It allows a user to acquire pre-specified information timely any time and anywhere.

### BRIEF DESCRIPTION OF THE DRAWINGS

FIG. 1 is a processing flow chart of a method for displaying a webpage fragment on a desktop provided by the application.

FIG. 2 is an example of a webpage fragment displayed on a desktop by the method of the application.

FIG. 3 is a schematic architectural diagram of an apparatus for displaying a webpage fragment on a desktop provided by the application.

FIG. 4 is a processing flow chart of a method for acquiring and transmitting feature information of webpage fragment provided by the application.

FIG. 5 is a schematic architectural diagram of an apparatus for acquiring and transmitting feature information of webpage fragment provided by the application.

FIG. 6 is a processing flow chart of a method for acquiring and processing webpage resources provided by the application.

FIG. 7 is a schematic architectural diagram of an apparatus for acquiring and processing webpage resources provided by the application.

FIG. 8 is a schematic architectural diagram of a system for taking a snapshot of webpage fragment to display on a desktop provided by the application.

### DETAILED DESCRIPTION

To illustrate the technical solutions in the embodiments of the present disclosure, several drawings and many details are introduced in the following. These drawings and details show some embodiments of the present disclosure. The invention may still be implemented by many alternative methods or forms different from the embodiments described here. A person having ordinary skill in the art may derive other drawings and details from these drawings details without creative efforts. Accordingly, the application should not be limited to the following disclosed embodiments.

The present application discloses a method for displaying a webpage fragment on a desktop. The present application also discloses an apparatus for displaying a webpage fragment on a desktop, a method for acquiring and transmitting feature information of webpage fragment, an apparatus for acquiring and transmitting feature information of webpage fragment, a method for acquiring and processing webpage resources, an apparatus for acquiring and processing webpage resources, and a system for taking a snapshot of webpage fragment to display on a desktop.

The embodiments of the method for displaying a webpage fragment on a desktop is as follows:

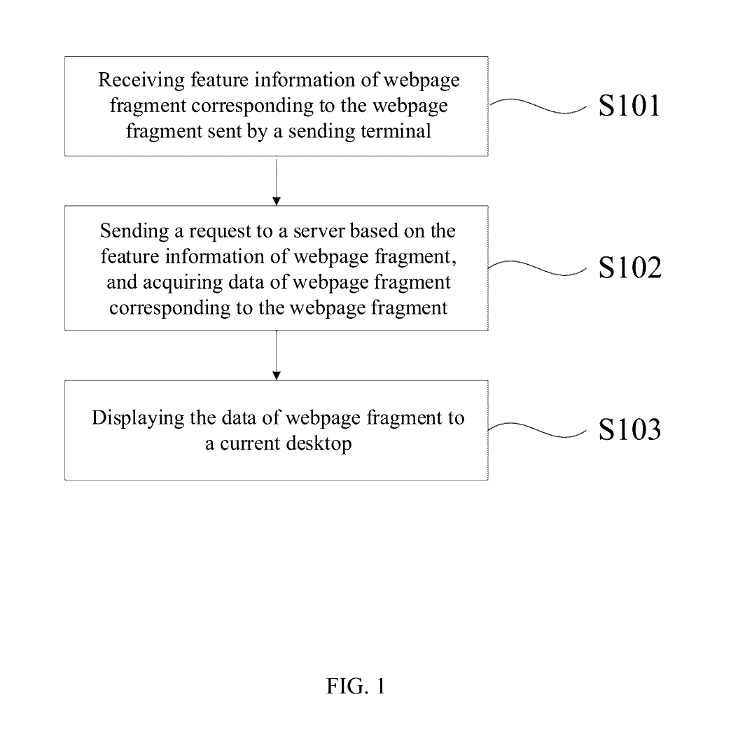

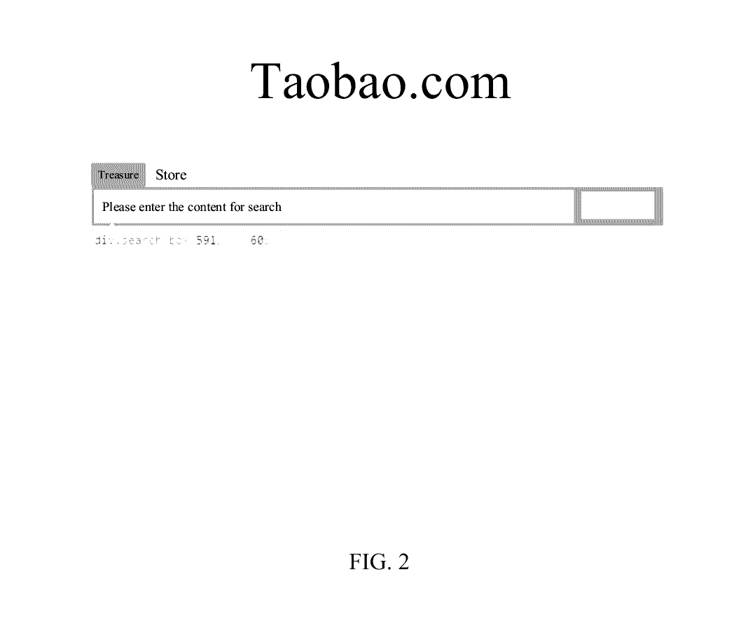

FIGS. 1 and 2 illustrate a method of displaying a webpage fragment on a desktop according to this embodiment, including:

FIG. 1 is a processing flow chart of a method for displaying a webpage fragment on a desktop in accordance with this embodiment. FIG. 2 is a schematic diagram of a webpage fragment in a method of displaying a webpage fragment on a desktop according to this embodiment.

Refer to FIG. 1, which is a processing flow chart of a method of displaying a webpage fragment on a desktop in accordance with this embodiment.

The method of displaying a webpage fragment on a desktop described in this embodiment refers to a method of displaying a webpage fragment on a desktop of a receiving terminal. The method includes the following steps:

S101: receiving feature information of webpage fragment corresponding to the webpage fragment sent by a sending terminal.

The entity that snapshots the webpage fragment, corresponding to the mentioned webpage fragment, to generate the feature information of webpage fragment and sends the feature information of webpage fragment is the sending terminal, and the entity that receives and processes the feature information of webpage fragment is the receiving terminal.

In this embodiment, the sending terminal is set on a PC terminal, and the receiving terminal is set on a mobile phone terminal. In addition, the receiving terminal may also be set on terminal devices such as a tablet computer, a PC and/or a television.

For the receiving terminal, before the feature information of webpage fragment corresponding to the webpage fragment is sent to the receiving terminal, the following steps are further included:

1) The webpage fragment is snapshotted;

In this embodiment, the sending terminal snapshots the webpage fragment by using a browser installed on the PC terminal. For example, in a Chrome browser, the webpage fragment may be snapshotted by using an Extension plug-in, and during a webpage capturing process, coordinates of a region selected by dragging with a mouse may also be acquired, as shown in FIG. 2. In FIG. 2, the grey area corresponding to the search box is the webpage fragment.

2) The feature information of webpage fragment corresponding to the webpage fragment is extracted;

The webpage feature information includes: a URL of a webpage corresponding to the webpage fragment, screen resolution of a device corresponding to the sending terminal, and size and location information of the webpage fragment.

The step of extracting the feature information of webpage fragment corresponding to the webpage fragment is as follows:

a. The webpage fragment is represented as: [200, 300, 591, 60]; where 200 is the x-coordinate of the upper left corner of the webpage fragment, 300 is the y-coordinate of the upper left corner of the webpage fragment, 591 is the width of the webpage fragment, and 60 is the height of the webpage fragment.

b. The URL of the webpage corresponding to the webpage fragment is acquired by using a Window object in JavaScript.

The Window object represents a browser window or frame. A Location object is a part of the Window object, and the Location object includes information about a current URL.

The Location object is stored in a Location attribute of the Window object, and represents a Web URL of a document currently displayed in that window. A complete URL of the document is stored in a href attribute of the Location object, and other attributes of the Location object describe respective parts of the URL. When a Location object is converted into a character string, a value of the href attribute is returned.

In this embodiment, the URL of the webpage corresponding to the webpage fragment is acquired through window.location.href, for example, the URL is http://search.taobao.com/;

c. The screen resolution of a PC terminal corresponding to the sending terminal is acquired by using a Screen object in JavaScript.

The Screen object includes information about a display screen of a client terminal, and all browsers support this object. Information about a browser displaying screen is stored in the Screen object, and JavaScript programs optimize outputs thereof by using such information, so as to meet a display requirement of a user.

A height attribute of the Screen object returns the height of the display screen, and a width attribute of the Screen object returns the width of the display screen. A current screen width (resolution value), for example, 1366, is obtained by using Screen.width; and a current screen height (resolution value), for example, 768, is obtained by using Screen.height.

Through the three steps above, the feature information of webpage fragment corresponding to the webpage fragment is obtained, which is:

URL: http://search.taobao.com/

Dimension: [200, 300, 591, 60]

Screen: [1366*768]

After completing the two steps above, the sending terminal can send, to the receiving terminal, the feature information of webpage fragment corresponding to the webpage fragment.

Described above is a preferred implementation method in this embodiment; apart from that, other methods may also be used for implementation, which are not limited herein.

S102: sending a request to a server based on the feature information of webpage fragment, and acquiring data of webpage fragment corresponding to the webpage fragment.

This step includes: S102-1, sending the request to a proxy server based on the feature information of webpage fragment, and S102-2, receiving the data of webpage fragment, returned by the proxy server, corresponding to the feature information of webpage fragment.

S102-1: sending the request to a proxy server based on the feature information of webpage fragment.

In this embodiment, the receiving terminal sends, to the proxy server by using a built-in browser, a request for acquiring webpage fragment data corresponding to the webpage fragment. Before sending, to the proxy server by using the browser, the request for acquiring webpage fragment data corresponding to the webpage fragment, the receiving terminal further needs to establish a Transport Control Protocol (TCP) connection to the proxy server through a network. Once the receiving terminal establishes the TCP connection to the proxy server, the built-in browser of the receiving terminal sends a request to the proxy server, where the request is a request for acquiring webpage fragment data, and the request for acquiring webpage fragment data includes the feature information of webpage fragment.

S102-2: receiving the data of webpage fragment, returned by the proxy server, corresponding to the feature information of webpage fragment.

According to Step S102-1 above, after the proxy server receives the request, which is sent by the receiving terminal and carries the feature information of webpage fragment, for acquiring webpage fragment data, the proxy server reads, by using a kernel WebKit of the built-in browser, the URL of the webpage corresponding to the webpage fragment from the feature information of webpage fragment, and sends a request to a Web server by using a WebCore kernel in the WebKit. After receiving the request sent by the proxy server, the Web server reads information of the request. For example: the Web server reads information of the request from the proxy server, and if a request type is GET, the Web server acquires, from the information of the request, a name of an HTML file to be accessed. If the HTML file exists, the Web server opens the HTML file (one webpage corresponds to one HTML file) and returns Hypertext Transfer Protocol (HTTP) header information and content of the HTML file to the proxy server through a socket. After receiving all network resources related to the URL, the proxy server may use a DumpRenderTree function to obtain, at specified resolution (for example: [1366, 768]), appearance values after all elements on the webpage are rendered. Moreover, the proxy server organizes the values by using a Document Object Model (DOM) tree structure, determines, according to region data (for example: [200, 300, 591, 60]) in fragment description information, DOM elements related to the fragment snapshotted by the user, thereby obtaining minimum HTML codes required for rendering this fragment, that is, the webpage fragment data corresponding to the webpage fragment, and sends the webpage fragment data to the receiving terminal. The receiving terminal receives, by using the built-in browser, the webpage fragment data, which corresponds to the feature information of webpage fragment, returned by the proxy server.

It should be noted that, the network data resources acquired by the receiving terminal from the proxy server are merely the webpage fragment data corresponding to the feature information of webpage fragment, which reduces the consumption of data traffic caused by data downloading of the receiving terminal, and also reduces resource consumption caused when the browser of the receiving terminal loads the webpage fragment data.

In addition, sending a request to a server based on the feature information of webpage fragment, and acquiring webpage fragment data corresponding to the webpage fragment may further be implemented by using the following method:

sending a request to a Web server based on the URL;

receiving all network resources, which are related to the URL, returned by the Web server; and

parsing the network resources based on the feature information of webpage fragment to obtain the webpage fragment data corresponding to the webpage fragment.

S103: displaying the data of webpage fragment to a current desktop.

This step includes: S103-1, loading the resources of the webpage fragment based on the HTML codes of the webpage fragment; S103-2, performing standard parsing on the HTML codes of the webpage fragment, and then obtaining a webpage fragment control; and S103-3, performing scaling on the webpage fragment control based on screen resolution of the current desktop, and then displaying the webpage fragment control on the current desktop.

S103-1: loading the resources of the webpage fragment based on the HTML codes of the webpage fragment.

According to Step S102 above, after the receiving terminal receives the webpage fragment data corresponding to the feature information of webpage fragment, the built-in browser of the receiving terminal loads a related resource based on the HTML codes in the webpage fragment data.

S103-2: performing standard parsing on the HTML codes of the webpage fragment, and then obtaining a webpage fragment control.

According to Step S103-1 above, after the built-in browser of the receiving terminal completes loading the related resource based on the HTML codes in the webpage fragment data, the built-in browser of the receiving terminal obtains the webpage fragment control after performing standard parsing and execution of the HTML codes of the webpage fragment.

A process of performing standard parsing and execution of the HTML codes of the webpage fragment in this step and a process of loading a webpage fragment resource based on HTML codes of the webpage fragment in Step S103-1 above can be implemented based on a common browser. The resource loading process and the code parsing and execution process are internal execution processes of the browser, which are not the focus of the present application, and therefore are not described in detail herein.

S103-3: performing scaling on the webpage fragment control based on screen resolution of the current desktop, and then displaying the webpage fragment control on the current desktop.

The significance of performing this step lies in that, when a terminal on which the receiving terminal is set is a mobile phone, if the webpage fragment control obtained in Step S103-2 above is directly displayed on a current desktop of the mobile phone, the webpage fragment control may cover most of the screen of the mobile phone or the webpage fragment control may even exceed the display area of the mobile phone desktop, which affects user experience. In this step, proper scaling is performed on the webpage fragment control according to the screen resolution of the current desktop, and the webpage fragment control is displayed, on the current terminal desktop, in a size matching the screen resolution of the current desktop.

After this step, the method further includes the following step:

sending a request to the server based on the feature information of webpage fragment, acquiring webpage fragment data corresponding to the webpage fragment, and displaying, on the current desktop, a webpage fragment control generated from the webpage fragment data.

The function of this step is to update data in the webpage fragment displayed on the current desktop. For specific execution steps, refer to Steps S102 to S103 above, and details are not described again in this step; according to Step S103-3 above, the generated webpage fragment control is used to cover the webpage fragment control displayed on the current desktop, so as to implement a data updating process.

It should be noted that, in this step, the data updating process is specifically implemented while Step S102-2 is executed, which also saves resource consumption caused when the browser of the receiving terminal loads the webpage fragment data.

The embodiments of an apparatus for displaying a webpage fragment on a desktop are illustrated as follows:

The aforementioned embodiments provide a method for displaying a webpage fragment on a desktop. The application further provides an apparatus for displaying a webpage fragment on a desktop corresponding to the method.

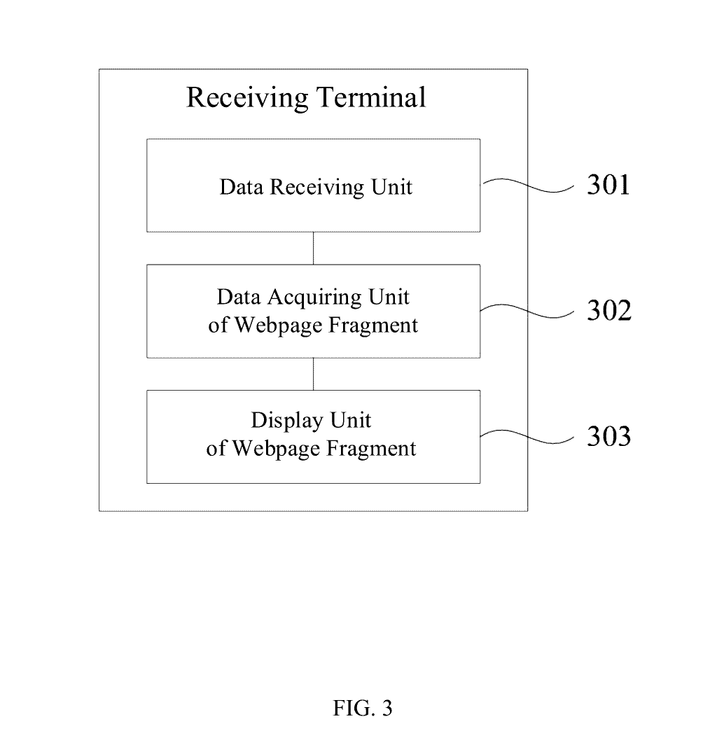

FIG. 3 is a schematic architectural diagram of an apparatus for displaying a webpage fragment on a desktop provided by the application. Because the operations of the apparatus are similar to the corresponding method, the description of the embodiments of the apparatus is simplified. More details of the operations could be referred to the corresponding method. The following description of the embodiments of the apparatus is for illustration only.

The application discloses an apparatus for displaying a webpage fragment on a desktop, comprising:

a data receiving unit 301 configured to receive feature information of webpage fragment corresponding to a webpage fragment sent by a sending terminal;

a data acquiring unit of webpage fragment 302 configured to send a request to a server based on the feature information of webpage fragment, and acquire data of webpage fragment corresponding to the webpage fragment; and

a display unit of webpage fragment 303 configured to display the data of webpage fragment to a current desktop.

In some embodiments, the apparatus for displaying the webpage fragment on the desktop further comprises:

a data update unit configured to:

sending a request to the server based on the feature information of webpage fragment; acquiring the data of webpage fragment corresponding to the webpage fragment; and displaying a webpage fragment control, generated from the data of webpage fragment, on the current desktop.

In some embodiments, the data acquiring unit of webpage fragment includes:

a data request subunit configured to send the request to a proxy server based on the feature information of webpage fragment; and

a data receiving subunit configured to receive the data of webpage fragment, returned by the proxy server, corresponding to the feature information of webpage fragment.

In some embodiments, the display unit of webpage fragment includes:

a loading subunit of webpage resources configured to load the resources of the webpage fragment based on the HTML codes of the webpage fragment;

a code-parsing subunit configured to perform standard parsing on the HTML codes of the webpage fragment, and then obtaining a webpage fragment control; and

a display-scaling subunit configured to perform scaling on the webpage fragment control based on screen resolution of the current desktop, and then displaying the webpage fragment control on the current desktop.

The embodiments of the aforementioned method for acquiring and transmitting feature information of webpage fragment are as follows:

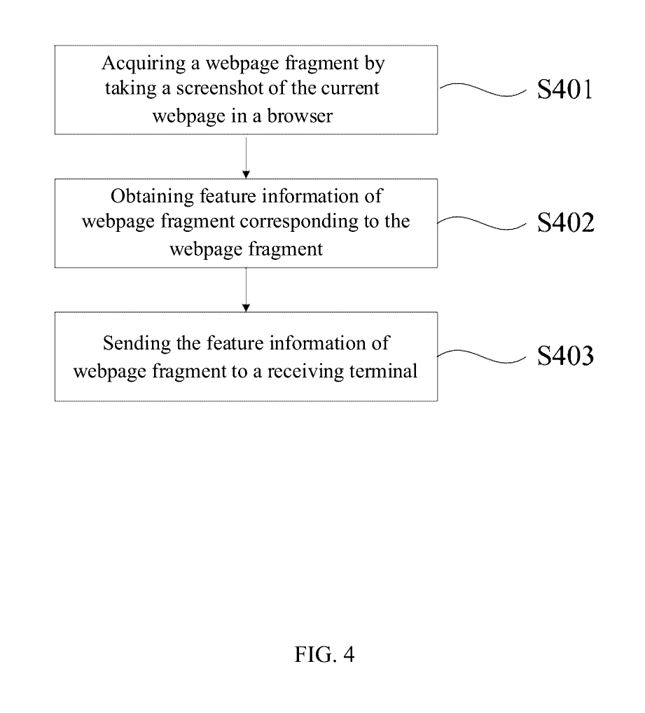

Refer to FIG. 4, which is a processing flow chart of a method of acquiring and sending feature information of webpage fragment according to this embodiment.

The method of acquiring and sending feature information of webpage fragment in this embodiment refers to a method of capturing a webpage fragment snapshotted on a desktop of a sending terminal and sending the snapshotted webpage fragment to a receiving terminal. The method includes the following steps:

S401: acquiring a webpage fragment by taking a screenshot of the current webpage in a browser.

The entity that snapshots the webpage fragment corresponding to the webpage fragment to generate the feature information of webpage fragment and sends the feature information of webpage fragment is the sending terminal, and the entity that receives and processes the feature information of webpage fragment is the receiving terminal.

In this embodiment, the sending terminal is set on a PC terminal, and the receiving terminal is set on a mobile phone terminal. In addition, the receiving terminal may also be set on terminal devices such as a tablet computer, a PC and/or a television.

In this embodiment, the sending terminal snapshots the webpage fragment by using a browser installed on the PC terminal. For example, in a Chrome browser, the webpage fragment may be snapshotted by using an Extension plug-in, and during a webpage capturing process, coordinates of a region selected by dragging with a mouse may also be acquired, as shown in FIG. 2. In FIG. 2, the grey area corresponding to the search box is the webpage fragment.

In addition, other methods may also be used to implement capturing a current webpage of the browser to obtain the webpage fragment, which are not limited herein.

S402: obtaining feature information of webpage fragment corresponding to the webpage fragment.

After capturing the webpage fragment, the sending terminal extracts webpage fragment information corresponding to the webpage fragment, and the webpage feature information extracted by the sending terminal includes: a URL of a webpage corresponding to the webpage fragment, screen resolution of a device corresponding to the sending terminal, and size and location information of the webpage fragment.

2) The feature information of webpage fragment corresponding to the webpage fragment is extracted;

The webpage feature information includes: a URL of a webpage corresponding to the webpage fragment, screen resolution of a device corresponding to the sending terminal, and size and location information of the webpage fragment.

The step of extracting the feature information of webpage fragment corresponding to the webpage fragment is as follows:

a. The webpage fragment is represented as: [200, 300, 591, 60]; where 200 is the x-coordinate of the upper left corner of the webpage fragment, 300 is the y-coordinate of the upper left corner of the webpage fragment, 591 is the width of the webpage fragment, and 60 is the height of the webpage fragment.

b. The URL of the webpage corresponding to the webpage fragment is acquired by using a Window object in JavaScript.

The Window object represents a browser window or frame. A Location object is a part of the Window object, and the Location object includes information about a current URL.

The Location object is stored in a Location attribute of the Window object, and represents a Web URL of a document currently displayed in that window. A complete URL of the document is stored in a href attribute of the Location object, and other attributes of the Location object describe respective parts of the URL. When a Location object is converted into a character string, a value of the href attribute is returned.

In this embodiment, the URL of the webpage corresponding to the webpage fragment is acquired through window.location.href, for example, the URL is http://search.taobao.com/;

c. The screen resolution of a PC terminal corresponding to the sending terminal is acquired by using a Screen object in JavaScript.

The Screen object includes information about a display screen of a client terminal, and all browsers support this object. Information about a browser displaying screen is stored in the Screen object, and JavaScript programs optimize outputs thereof by using such information, so as to meet a display requirement of a user.

A height attribute of the Screen object returns the height of the display screen, and a width attribute of the Screen object returns the width of the display screen. A current screen width (resolution value), for example, 1366, is obtained by using Screen.width; and a current screen height (resolution value), for example, 768, is obtained by using Screen.height.

Through the three steps above, the feature information of webpage fragment corresponding to the webpage fragment is obtained, which is:

URL: http://search.taobao.com/

Dimension: [200, 300, 591, 60]

Screen: [1366*768]

Apart from the method of extracting the feature information of webpage fragment corresponding to the webpage fragment in this step, other methods may also be used to extract the feature information of webpage fragment corresponding to the webpage fragment, which are not limited herein.

S403: sending the feature information of webpage fragment to a receiving terminal.

Before this step, the method further includes the following step:

establishing a communication link to the receiving terminal.

It should be noted that the step and the above-mentioned step for building up communication links with the receiving terminal is not the essential part of the application. Therefore, the description of these steps will be simplified.

In the aforementioned embodiments, the application provides a method for acquiring and transmitting the feature information of webpage fragment. The application also provides an apparatus, corresponding to the method, for acquiring and transmitting feature information of webpage fragment.

Because the operations of the apparatus are similar to the corresponding method, the description of the embodiments of the apparatus is simplified. More details of the operations could be referred to the corresponding method. The following description of the embodiments of the apparatus is for illustration only.

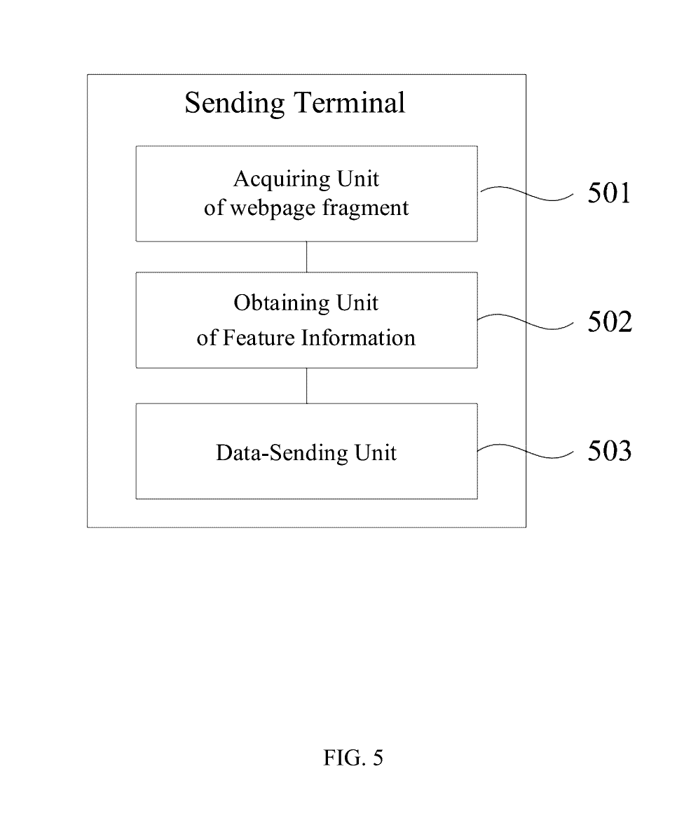

FIG. 5 illustrates a schematic architectural diagram of an apparatus for acquiring and transmitting feature information of webpage fragment provided by the application. The application provides an apparatus for acquiring and transmitting feature information of webpage fragment, comprising:

an acquiring unit of webpage fragment 501 configured to acquire a webpage fragment by taking a screenshot of the current webpage in a browser;

an obtaining unit of feature information 502 configured to obtain feature information of webpage fragment corresponding to the webpage fragment; and

a data-sending unit 503 configured to send the feature information of webpage fragment to a receiving terminal.

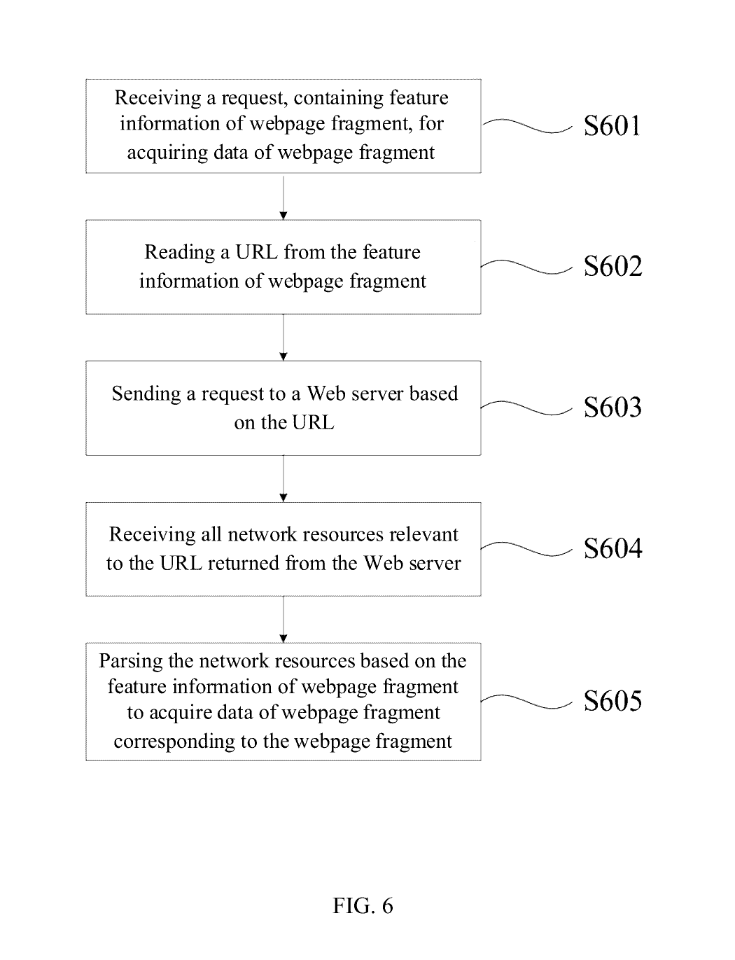

Refer to FIG. 6, which is a processing flow chart of a method of acquiring and processing a webpage resource according to this embodiment.

The method of acquiring and processing a webpage resource in this embodiment refers to a method of acquiring and processing a webpage resource on a proxy server side. The method includes the following steps:

S601: receiving a request, containing feature information of webpage fragment, for acquiring data of webpage fragment.

Before the proxy server receives the request, which is sent by the receiving terminal, for acquiring webpage fragment data, the receiving terminal establishes a TCP connection to the proxy server through a network. Once the receiving terminal establishes the TCP connection to the proxy server, the browser of the receiving terminal sends a request to the proxy server, where the request is a request for acquiring webpage fragment data, and the request for acquiring webpage fragment data includes the feature information of webpage fragment.

S602: reading a URL from the feature information of webpage fragment.

According to Step S601 above, after the proxy server receives the request, which is sent by the receiving terminal and carries the feature information of webpage fragment, for acquiring webpage fragment data, the proxy server reads, by using a kernel WebKit of the built-in browser, the URL of the webpage corresponding to the webpage fragment from the feature information of webpage fragment.

S603: sending a request to a Web server based on the URL.

The proxy server is deployed with the browser kernel WebKit, and sends the request to the Web server by using a WebCore kernel in the WebKit.

The WebCore kernel does not implement the HTTP protocol by itself, but invokes HTTP libraries of different platforms to implement functions of the HTTP protocol. The HTTP protocol follows a request→response mechanism, that is: one URL corresponds to one request→response chain, while in a webpage, any resource corresponds to one URL. If the proxy server wants to apply for a resource from the Web server, the proxy server initiates an HTTP request to the Web server by using the kernel WebKit of the built-in browser.

S604: receiving all network resources relevant to the URL returned from the Web server.

After receiving the request sent by the proxy server, the Web server reads information of the request.

For example, the Web server reads the information of the request from the proxy server.

If a request type is GET, the Web server acquires a name of an HTML file to be accessed from the information of the request.

If the HTML file exists, the Web server opens the HTML file (one webpage corresponds to one HTML file) and returns HTTP header information and content of the HTML file to the proxy server through a socket.

S605: parsing the network resources based on the feature information of webpage fragment to acquire data of webpage fragment corresponding to the webpage fragment.

After the proxy server receives all network resources related to the URL by using the kernel WebKit of the built-in browser, a DumpRenderTree function may be used to obtain, at specified resolution (for example: [1366, 768]), appearance values after all elements on the webpage are rendered, and the values are organized by using a DOM tree structure.

In this way, DOM elements related to the fragment snapshotted by the user can be determined according to region data (such as [200, 300, 591, 60] in the example above) in fragment description information, thereby obtaining minimum HTML codes required for rendering this fragment, that is, the webpage fragment data corresponding to the webpage fragment.

After this step, the method further includes the following step:

sending the webpage fragment data to the receiving terminal.

An embodiment of the apparatus for acquiring and processing the webpage resource is as follows:

In the aforementioned embodiments, the application provides a method for acquiring and processing webpage resources. The application also provides an apparatus, corresponding to the method, for acquiring and processing webpage resources.

Because the operations of the apparatus are similar to the corresponding method, the description of the embodiments of the apparatus is simplified. More details of the operations could be referred to the corresponding method. The following descriptions of the embodiments of the apparatus is for illustration only.

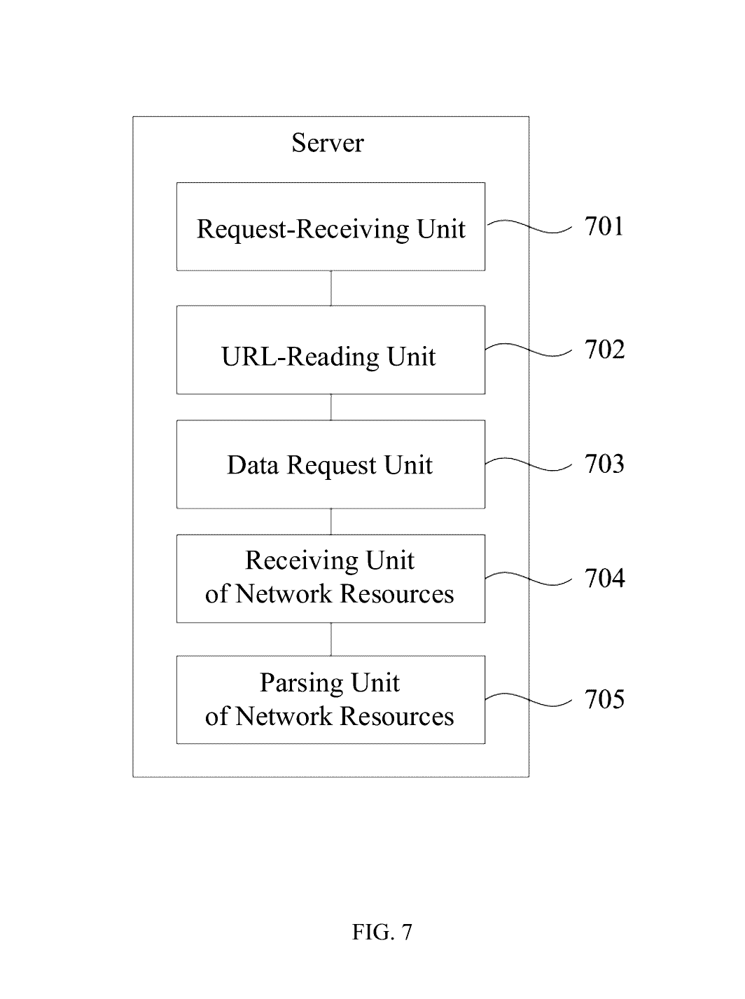

FIG. 7 is a schematic architectural diagram of an apparatus for acquiring and processing webpage resources provided by the application.

The application provides an apparatus for acquiring and processing webpage resources, comprising:

a request-receiving unit 701 configured to receive a request, containing feature information of webpage fragment, for acquiring data of webpage fragment;

a URL-reading unit 702 configured to read a URL from the feature information of webpage fragment;

a data request unit 703 configured to send a request to a Web server based on the URL;

a receiving unit of network resources 704 configured to receive all network resources relevant to the URL returned from the Web server; and

a parsing unit of network resources 705 configured to parse the network resources based on the feature information of webpage fragment to acquire data of webpage fragment corresponding to the webpage fragment.

In some embodiments, the apparatus for acquiring and processing webpage resources further comprises:

a data-sending unit configured to send the data of webpage fragment to a receiving terminal.

The embodiments of the aforementioned system for taking a snapshot of webpage fragment to display on a desktop are as follows:

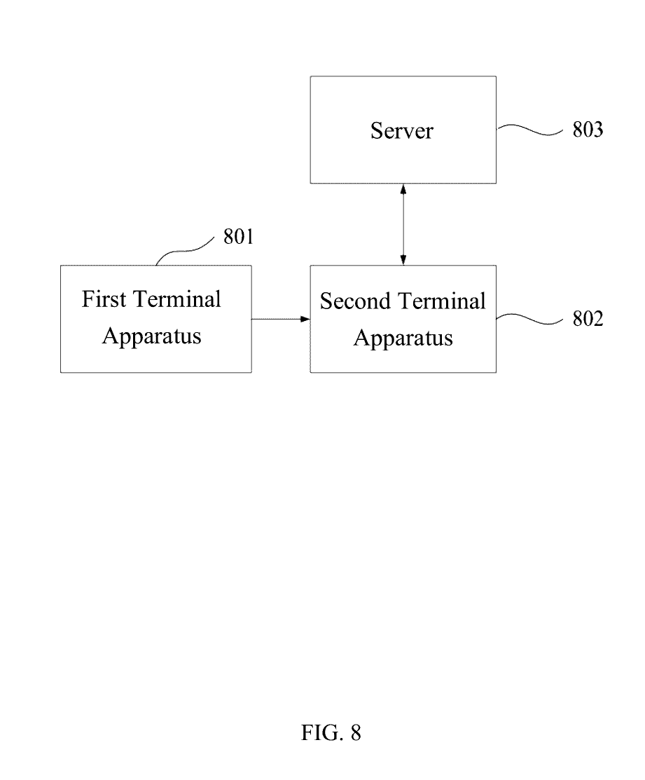

FIG. 8 is a schematic architectural diagram of a system for taking a snapshot of webpage fragment to display on a desktop provided by the application.

In the aforementioned embodiments, the application provides the apparatus for acquiring and transmitting feature information of webpage fragment, the apparatus for displaying the webpage fragment on the desktop, and the apparatus for acquiring and processing webpage resources. The application further provides a system for taking a snapshot of webpage fragment to display on a desktop.

The aforementioned system for taking a snapshot of webpage fragment to display on a desktop, comprising:

The apparatus for acquiring and transmitting feature information of webpage fragment, the apparatus for displaying the webpage fragment on the desktop, and the apparatus for acquiring and processing webpage resources.

The operations of the apparatus for acquiring and transmitting feature information of webpage fragment, the apparatus for displaying the webpage fragment on the desktop, and the apparatus for acquiring and processing webpage resources can be referred to the above descriptions of the method for acquiring and transmitting feature information of webpage fragment, the method for displaying the webpage fragment on the desktop, and the method for acquiring and processing webpage resources. Those operations of the three apparatuses are simplified in this embodiment.

The following descriptions of the system are for illustration.

The application provides a system for taking a snapshot of webpage fragment to display on a desktop, comprising:

a first terminal apparatus 801, the first terminal apparatus being equipped with the apparatus for acquiring and transmitting feature information of webpage fragment;

a second terminal apparatus 802, the second terminal apparatus being equipped with the apparatus for displaying the webpage fragment on the desktop; and

a server 803, the server being equipped with the apparatus for acquiring and processing webpage resources.

In some embodiments, the first terminal apparatus includes a PC.

In some embodiments, the second terminal apparatus includes a mobile phone, a tablet, a PC, and/or a television.

The present invention is described with reference to the method and apparatus (system) of the embodiments of the present invention. It should be understood that each process and/or block in the flow chart and/or block diagram and a combination of processes and/or blocks in the flow chart and/or block diagram may be implemented by using computer program instructions in combination with an information sensing device. These computer program instructions may be provided to a general-purpose computer, an application-specific computer, an embedded processor or a processor of other programmable data processing devices to generate a machine, so that the instructions, which are executed by the computer or the processor of other programmable data processing devices, in coordination with the information sensing device generate an apparatus for implementing functions specified in one or more processes in the flow chart and/or in one or more blocks in the block diagram.

These computer program instructions may also be stored in a computer readable memory capable of guiding a computer or other programmable data processing devices to work in a particular manner, so that the instructions stored in the computer readable memory generate a product including an instruction apparatus, where the instruction apparatus implements functions specified in one or more processes in the flow chart and/or in one or more blocks in the block diagram.

These computer program instructions may also be loaded to a computer or other programmable data processing devices, so that a series of operation steps are executed on the computer or other programmable devices to generate computer-implemented processing, and therefore the instructions executed on the computer or other programmable devices provide steps for implementing functions specified in one or more processes in the flow chart and/or in one or more blocks in the block diagram.

In a typical configuration, a computing device includes one or more central processing units (CPU), an input/output interface, a network interface, and a memory.

The memory may include forms such as a non-permanent memory, a random access memory (RAM) and/or a non-volatile memory among computer readable media, for example, a read-only memory (ROM) or a flash random access memory (flash RAM). The memory is an example of the computer readable media.

The computer readable media include permanent and non-permanent, mobile and immobile media, and can implement information storage by using any method or technology. Information may be a computer readable instruction, a data structure, a program module, or other data. Examples of the storage media of a computer include, but are not limited to: a phase change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, a magnetic tape disk storage or other magnetic storage devices, or other non-transmission media, which may be used to store information accessible to the computer device. According to the definition herein, the computer readable media do not include transitory computer readable media, for example, modulated data signals and carriers.

It should also be noted that, the terms “include”, “comprise” or any other variation thereof intend to cover non-exclusive inclusion, so that a process, method, product, or device including a series of elements not only includes those elements but also includes other elements that are not listed explicitly, or further includes intrinsic elements of the process, method, product or device. Without more restrictions, an element modified by the phrase “including a . . . ” does not preclude the process, method, product or device including the element from further including other identical elements.

The above description is merely embodiments of the present disclosure, but is not intended to limit the present disclosure. For those skilled in the art, the present disclosure can have various changes and variations. Any modification, equivalent replacement, and improvement made without departing from the spirit and principle of the present disclosure shall fall in the scope of the claims of the present disclosure.

It is intended that the disclosure and examples be considered as exemplary only, with a true scope and spirit of disclosed embodiments being indicated by the following claims.

1. A method for displaying a webpage fragment on a desktop, the method comprising:
receiving feature information of webpage fragment corresponding to the webpage fragment sent by a sending terminal;
sending a request to a server based on the feature information of webpage fragment, and acquiring data of webpage fragment corresponding to the webpage fragment; and
displaying the data of webpage fragment to a current desktop.

2. The method for displaying the webpage fragment on the desktop according to claim 1, wherein the feature information of webpage fragment includes:
a first uniform resource locator (URL) of a webpage corresponding to the webpage fragment, screen resolution of the sending terminal, and size and location information of the webpage fragment; or
a second uniform resource locator (URL) of a webpage corresponding to the webpage fragment, screen resolution of the sending terminal, and location information of all vertices of the webpage fragment.

3. The method for displaying the webpage fragment on the desktop according to claim 1, wherein after displaying a webpage fragment control, generated from the data of webpage fragment, on the current desktop, the method further comprises:
executing the following step of data update in accordance with a set cycle:
sending a request to the server based on the feature information of webpage fragment;
acquiring the data of webpage fragment corresponding to the webpage fragment; and
displaying a webpage fragment control generated from the data of webpage fragment on the current desktop.

4. The method for displaying the webpage fragment on the desktop according to claim 1, wherein the webpage fragment includes:
a screenshot of the whole current webpage in a browser of the sending terminal; or
a screenshot of a part of the current webpage in a browser of the sending terminal.

5. The method of displaying the webpage fragment on the desktop according to claim 1, wherein sending the request to the server based on the feature information of webpage fragment and acquiring the data of webpage fragment corresponding to the webpage fragment include:
sending the request to a proxy server based on the feature information of webpage fragment; and
receiving the data of webpage fragment, returned by the proxy server, corresponding to the feature information of webpage fragment.

6. The method for displaying the webpage fragment on the desktop according to claim 1, wherein sending the request to the server based on the feature information of webpage fragment and acquiring the data of webpage fragment corresponding to the webpage fragment include:
sending the request to a Web server based on a uniform resource locator (URL);
receiving all network resources related to the URL returned by the Web server; and
parsing the network resources based on the feature information of webpage fragment to acquire the data of webpage fragment corresponding to the webpage fragment.

7. The method for displaying the webpage fragment on the desktop according to claim 1, wherein the data of webpage fragment includes Hypertext Markup Language (HTML) codes of the webpage fragment and the resources of the webpage fragment.

8. The method for displaying the webpage fragment on the desktop according to claim 7, wherein displaying the data of webpage fragment to the current desktop includes:
loading the resources of the webpage fragment based on the HTML codes of the webpage fragment;
performing standard parsing on the HTML codes of the webpage fragment, and then obtaining a webpage fragment control; and
performing scaling on the webpage fragment control based on screen resolution of the current desktop, and then displaying the webpage fragment control on the current desktop.

9. The method for displaying the webpage fragment on the desktop according to claim 6, wherein sending the request to the Web server based on the URL, receiving the all network resources related to the URL returned by the Web server, and parsing the network resources based on the feature information of webpage fragment to acquire the data of webpage fragment corresponding to the webpage fragment are implemented based on an internal kernel of browser WebKit.

10. The method for displaying the webpage fragment on the desktop according to claim 6, wherein parsing the network resources based on the feature information of webpage fragment to acquire the data of webpage fragment corresponding to the webpage fragment is implemented based on a DumpRenderTree function in a browser kernel WebKit.

11. The method for displaying the webpage fragment on the desktop according to claim 8, wherein the following steps are implemented based on a Web-based OS operating environment: the step of loading the webpage fragment resource based on the webpage fragment HTML codes, the step of obtaining a webpage fragment control after performing standard parsing and execution of webpage fragment HTML codes, and the step of performing scaling on the webpage fragment control based on screen resolution of the current desktop and then displaying the webpage fragment control on the current desktop.

12. An apparatus for displaying a webpage fragment on a desktop, comprising:
a data receiving unit that receives feature information of webpage fragment corresponding to a webpage fragment sent by a sending terminal;
a data acquiring unit of webpage fragment that sends a request to a server based on the feature information of webpage fragment, and that acquires data of webpage fragment corresponding to the webpage fragment; and
a display unit of webpage fragment that displays the data of webpage fragment to a current desktop.

13. The apparatus for displaying the webpage fragment on the desktop according to claim 12, further comprising:
a data update unit that:
sends a request to the server based on the feature information of webpage fragment;
acquires the data of webpage fragment corresponding to the webpage fragment; and
provides for display a webpage fragment control, generated from the data of webpage fragment, on the current desktop.

14. The apparatus for displaying the webpage fragment on the desktop according to claim 12, wherein the data acquiring unit of webpage fragment includes:
a data request subunit that sends the request to a proxy server based on the feature information of webpage fragment; and
a data receiving subunit that receives the data of webpage fragment, returned by the proxy server, corresponding to the feature information of webpage fragment.

15. The apparatus for displaying the webpage fragment on the desktop according to claim 12, wherein the display unit of webpage fragment includes:
a loading subunit of webpage resources that loads the resources of the webpage fragment based on Hypertext Markup Language (HTML) codes of the webpage fragment;
a code-parsing subunit that performs standard parsing on the HTML codes of the webpage fragment, and that obtains a webpage fragment control; and
a display-scaling subunit that performs scaling on the webpage fragment control based on screen resolution of the current desktop, and that displays the webpage fragment control on the current desktop.

16. A method for acquiring and transmitting feature information of webpage fragment, comprising:
acquiring a webpage fragment by taking a screenshot of the current webpage in a browser;
obtaining feature information of webpage fragment corresponding to the webpage fragment; and
sending the feature information of webpage fragment to a receiving terminal.

17. The method for acquiring and transmitting the feature information of webpage fragment according to claim 16, wherein the feature information of webpage fragment includes:
a first uniform resource locator (URL) of a webpage corresponding to the webpage fragment, screen resolution of the sending terminal, and size and location information of the webpage fragment; or
a second uniform resource locator (URL) of a webpage corresponding to the webpage fragment, screen resolution of the sending terminal, and location information of all vertices of the webpage fragment.

18. The method for acquiring and transmitting feature information of webpage fragment according to claim 17, wherein at least one of the first URL and the second URL is implemented based on the JavaScript Window Object.

19. The method for acquiring and transmitting feature information of webpage fragment according to claim 17, wherein the screen resolution of the sending terminal is implemented based on the JavaScript Screen Object.

20. The method for acquiring and transmitting the feature information of webpage fragment according to claim 16, wherein before sending the feature information of webpage fragment to the receiving terminal, the method further comprises:
establishing a communication link with the receiving terminal, wherein the communication link includes one of the following forms:
a wired communication link;
a wireless communication link in a regional network established based on Wi-Fi or Bluetooth; and
a long-distance point-to-point communication link established on the Internet.

21. An apparatus for acquiring and transmitting feature information of webpage fragment, comprising:
an acquiring unit of webpage fragment that acquires a webpage fragment by taking a screenshot of the current webpage in a browser;
an obtaining unit of feature information that obtains feature information of webpage fragment corresponding to the webpage fragment; and
a data-sending unit that sends the feature information of webpage fragment to a receiving terminal.

22. A method for acquiring and processing webpage resources, comprising:
receiving a request, containing feature information of webpage fragment, for acquiring data of webpage fragment;
reading a uniform resource locator (URL, from the feature information of webpage fragment;
sending a request to a Web server based on the URL;
receiving all network resources relevant to the URL returned from the Web server; and
parsing the network resources based on the feature information of webpage fragment to acquire data of webpage fragment corresponding to the webpage fragment.

23. The method for acquiring and processing the webpage resources according to claim 22, wherein after parsing on the network resources based on the feature information of webpage fragment to acquire the data of webpage fragment corresponding to the webpage fragment, the method further comprises:
sending the data of webpage fragment to a receiving terminal.

24. The method for acquiring and processing webpage resources according to claim 22 or 23, wherein the method is implemented based on a browser kernel WebKit.

25. The method for acquiring and processing the webpage resources according to claim 22, wherein parsing the network resources based on the feature information of webpage fragment to acquire the data of webpage fragment corresponding to the webpage fragment are implemented based on an internal kernel of browser WebKit.

26. An apparatus for acquiring and processing webpage resources, comprising:
a request-receiving unit that receives a request, containing feature information of webpage fragment, for acquiring data of webpage fragment;
a URL-reading unit that reads a uniform resource locator (URL) from the feature information of webpage fragment;
a data request unit that sends a request to a Web server based on the URL;
a receiving unit of network resources that receives all network resources relevant to the URL returned from the Web server; and
a parsing unit of network resources that parses the network resources based on the feature information of webpage fragment to acquire data of webpage fragment corresponding to the webpage fragment.

27. The apparatus for acquiring and processing webpage resources according to claim 26, further comprising:
a data-sending unit that sends the data of webpage fragment to a receiving terminal.

28-32. (canceled)

33. A non-transitory computer readable medium that stores a set of instructions that is executable by at least one processor of a computer to cause the computer to perform a method for displaying a webpage fragment on a desktop, the method comprising:
receiving feature information of webpage fragment corresponding to the webpage fragment sent by a sending terminal;
sending a request to a server based on the feature information of webpage fragment, and acquiring data of webpage fragment corresponding to the webpage fragment; and
displaying the data of webpage fragment to a current desktop.

34. A non-transitory computer readable medium that stores a set of instructions that is executable by at least one processor of a computer to cause the computer to perform a method for acquiring and transmitting feature information of webpage fragment, the method comprising:
acquiring a webpage fragment by taking a screenshot of the current webpage in a browser;
obtaining feature information of webpage fragment corresponding to the webpage fragment; and
sending the feature information of webpage fragment to a receiving terminal.

35. A non-transitory computer readable medium that stores a set of instructions that is executable by at least one processor of a computer to cause the computer to perform a method for acquiring and processing webpage resources, the method comprising:
receiving a request, containing feature information of webpage fragment, for acquiring data of webpage fragment;
reading a uniform resource locator (URL) from the feature information of webpage fragment;
sending a request to a Web server based on the URL;
receiving all network resources relevant to the URL returned from the Web server; and
parsing the network resources based on the feature information of webpage fragment to acquire data of webpage fragment corresponding to the webpage fragment.
